(19) United States
(12) Patent Application Publication
(10) Pub. No.: US 2025/0118775 A1
(43) Pub. Date: Apr. 10, 2025

(54) UNIT CELL OF FUEL CELL STACK

(71) Applicants: Hyundai Motor Company, Seoul (KR); Kia Corporation, Seoul (KR)

(72) Inventors: Jin Hyeok Yoo, Yongin-si (KR); Seung Hun Han, Osan-si (KR)

(21) Appl. No.: 18/412,780

(22) Filed: Jan. 15, 2024

(30) Foreign Application Priority Data
Oct. 5, 2023 (KR) 10-2023-0132720

(51) Int. Cl. H01M 8/0258; H01M 8/0267; H01M 8/0273; H01M 8/1004; H01M 8/2483

(52) U.S. Cl. CPC H01M 8/0258; H01M 8/0267; H01M 8/0273; H01M 8/1004; H01M 8/2483

(57) ABSTRACT

An embodiment unit cell of a fuel cell stack includes an EGA in which a MEA and a GDL are bonded, a sheet including an insertion groove and a through hole for flowing a gas therethrough, wherein the EGA is insertable into the insertion groove, a first separator coupled to the sheet and including a first reaction flow field through which a first gas flows on a first side of the first separator, and a second separator coupled to the sheet and including a second reaction flow field through which a second gas flows on a first side of the second separator, a second gas flow field connected to a first or second end of the second reaction flow field, and a first gas flow field connected to the first reaction flow field through the through hole disposed at a point spaced apart from the second gas flow field.

### CROSS-REFERENCE TO RELATED APPLICATIONS

The present application claims the benefit of Korean Patent Application No. 10-2023-0132720, filed on Oct. 5, 2023, which application is hereby incorporated herein by reference.

### TECHNICAL FIELD

The disclosure relates to a unit cell of a fuel cell stack.

### BACKGROUND

A fuel cell is a device that receives hydrogen and air from an outside and generates electrical energy through an electrochemical reaction inside a fuel cell stack, and it can be used as a power source in various fields such as fuel cell vehicles (FCEVs) and fuel cells for power generation.

The fuel cell system includes a fuel cell stack that stacks a plurality of unit cells used as a power source, a fuel supply system that supplies hydrogen, which is a fuel, to the fuel cell stack, an air supply system that supplies oxygen, which is an oxidizing agent necessary for electrochemical reactions, a water and heat management system that controls the temperature of the fuel cell stack, and the like.

When hydrogen is supplied to the anode of the fuel cell stack and air is supplied to the cathode, an electrochemical reaction occurs between hydrogen and oxygen in the air, generating electrical energy and water (produced water).

Meanwhile, FIG. 1 is a diagram illustrating the configuration of a typical fuel cell stack.

As may be seen in FIG. 1, in a unit cell forming a typical fuel cell stack, a membrane electrode assembly (MEA) 10 is located at the innermost side, and the membrane electrode assembly 10 is composed of a polymer electrolyte membrane 11 capable of moving hydrogen cations (protons) and a catalyst layer coated on both sides of the polymer electrolyte membrane, that is, a fuel electrode (anode) 12 and an air electrode (cathode) 13.

Furthermore, a pair of gas diffusion layers (GDLs) 20 are stacked on the external portion of the membrane electrode assembly 10, that is, on the external portion where the fuel electrode 12 and the air electrode 13 are located, and a separator assembly 30 having a flow field formed therein to supply fuel and discharge water generated by the reaction is positioned outside the gas diffusion layer 20 with a gasket 40 interposed therebetween.

Here, the separator assembly 30 is formed by bonding an anode separator 31 provided on the anode and a cathode separator 32 provided on the cathode while facing each other.

Meanwhile, a fuel cell stack is formed by stacking a plurality of unit cells, and an end plate 50 for supporting and fixing each of the above-described components is coupled to the outermost side of the stacked unit cells.

Here, the anode separator 31 provided in any one unit cell is stacked to face the cathode separator 32 of another unit cell provided adjacent to the formerly mentioned unit cell.

Accordingly, the separator assembly 30, in which the cathode separator 32 and the anode separator 31 of adjacent unit cells provided to face each other are integrated, is used to construct a unit cell to smoothly perform the stacking process of the unit cells and maintain the alignment of the respective unit cells.

Here, the anode separator 31 and the cathode separator 32 forming the separator assembly 30 are bonded and integrated, so that manifolds communicate with each other, and each reaction region is configured in a similar shape to be disposed at the same position.

Meanwhile, the gasket 40 that forms an airtight line and flow path for the reaction gas or cooling water is formed on the surfaces of the anode separator 31 and the cathode separator 32 using an injection molding method.

The matters described as background technology above are only for the purpose of enhancement of understanding of the background of embodiments of the disclosure and should not be taken as an acknowledgement that they correspond to the prior art already known to a person skilled in the art.

### SUMMARY

The disclosure relates to a unit cell of a fuel cell stack. Particular embodiments relate to a unit cell of a fuel cell stack to which a sheet into which an electricity-generating assembly (EGA) can be inserted is applied.

Embodiments of the disclosure provide a unit cell of a fuel cell stack that can suppress deformation of first and second separators by a gasket provided on both sides of the second separator even when a large number of fuel cells are stacked.

In addition, embodiments of the disclosure provide a unit cell of a fuel cell stack that can maintain a uniform surface pressure at all points of the cells even when a plurality of fuel cells are stacked and can maintain airtightness by forming a flow path for reaction gas by the gasket provided on the second separator to face a sheet and the sheet when stacking the fuel cells.

A unit cell of a fuel cell stack according to embodiments of the disclosure comprises an electricity-generating assembly (EGA) in which a membrane electrode assembly and a gas diffusion layer are bonded, a sheet including an insertion groove into which the EGA is inserted and a through hole through which gas flows at a plurality of points, a first separator that is coupled to the sheet and includes a first reaction flow field through which a first gas flows on one side of the first separator, and a second separator that is coupled to the sheet, and a second reaction flow field through which a second gas flows is formed on one side of the second separator, a second gas flow field is connected to one or more of one end and the other end of the second reaction flow field, and a first gas flow field is connected to the first reaction flow field through the through hole formed in the sheet at a point spaced apart from the second gas flow field.

The gas diffusion layer of the EGA may include a first gas diffusion layer and a second gas diffusion layer, an area of the first gas diffusion layer may be smaller than an area of the second gas diffusion layer, and the first gas diffusion layer may be inserted into the insertion groove of the sheet so that one side of the sheet may be in contact with the membrane electrode assembly.

A first gas manifold through which the first gas flows in and out and a second gas manifold through which the second gas flows in and out may be formed at a plurality of points at one or more of the first separator, the second separator, and the sheet.

The first gas flow field may be connected to the first gas manifold formed in the second separator, and the second gas flow field may be connected to the second gas manifold formed in the second separator.

The first gas may flow into the first gas flow field through the first gas manifold, and the first gas flowing into the first gas flow field may pass through the through hole of the sheet and flow into the first reaction flow field of the first separator.

One end of the first gas flow field may be bent and connected to the through hole.

A gasket may be provided around one or more of the first gas manifold, the second gas manifold, the second reaction flow field, the first gas flow field, and the second gas flow field formed on one side of the second separator.

The gasket provided around one or more of the first gas manifold, the second gas manifold, and the second reaction flow field may be provided to be continuous, and the gasket provided around one or more of the first gas flow field and the second gas flow field may be provided to be discontinuous.

The gasket may be provided between adjacent first gas flow fields or adjacent second gas flow fields.

The gasket provided around one or more of the first gas manifold and the second gas manifold may be discontinuously provided.

A coolant manifold through which coolant flows in and out is formed on one or more of the first separator, the second separator, and the sheet on which the first gas manifold and the second gas manifold may be formed, and a coolant flow field through which the coolant flows may be formed on the other side of the first separator or the second separator.

The gasket may be provided around one or more of the first gas manifold, the second gas manifold, the coolant manifold, and the coolant flow field formed on the other side of the second separator.

The gasket provided around one or more of the first gas manifold and the second gas manifold may be provided to surround one or more of the first gas manifold and the second gas manifold.

A gasket may be provided on one side and the other side of the second separator, and an adhesive may be applied around the gasket to attach the second separator to the sheet.

According to the unit cell of the fuel cell stack of embodiments of the disclosure, the deformation of the first and second separators can be prevented by the gaskets provided on both sides of the second separator even when a large number of fuel cells are stacked, and even if a plurality of fuel cells are stacked, uniform surface pressure can be maintained at all points of the cells.

In addition, when the sheet provided separately from the separator is punched into a desired shape and placed between a pair of separators, the gasket provided on the separator to face the sheet and the sheet form a flow path for the reaction gas, so that double-tightness can be maintained.

### BRIEF DESCRIPTION OF THE DRAWINGS

FIG. 1 is a diagram illustrating the configuration of a typical fuel cell stack.

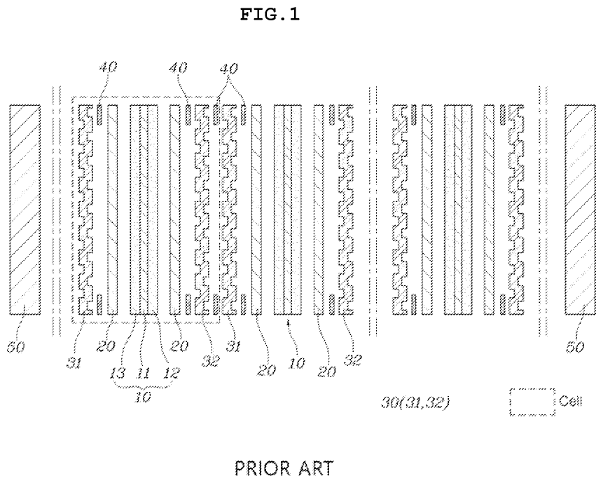

FIG. 2 is a diagram illustrating an exploded view of a unit cell of a fuel cell stack according to an embodiment of the disclosure.

FIG. 3 is a diagram illustrating one side of a second separator of a unit cell where the A-A′ cross section and the B-B′ cross section are illustrated when cells are stacked.

FIG. 4 is a diagram illustrating one side of a second separator of a unit cell where the C-C′ cross section and the D-D′ cross section are illustrated when cells are stacked.

FIG. 5 is a diagram illustrating a gasket provided on a second separator according to a second embodiment.

FIG. 6 is a diagram illustrating the cooling surface of a second separator according to a second embodiment.

FIG. 7 is a diagram illustrating the E-E′ cross section when the other side of a second separator and cells are stacked.

FIG. 8 is a diagram illustrating an EGA coupled to a sheet and the sheet.

### DETAILED DESCRIPTION OF ILLUSTRATIVE EMBODIMENTS

Hereinafter, embodiments disclosed in the present specification will be described in detail with reference to the accompanying drawings, but the same or similar elements are denoted by the same reference numerals throughout the figures, and redundant descriptions thereof will be omitted.

In describing embodiments disclosed in this specification, a detailed description of relevant well-known technologies may not be given in order not to obscure the subject matter of the embodiments of the disclosure. In addition, the accompanying drawings are merely intended to facilitate understanding of the embodiments disclosed in this specification and not to restrict the technical spirit disclosed in this specification. In addition, the accompanying drawings should be understood as covering all changes, equivalents, or substitutions within the spirit and technology scope of the disclosure.

Although the terms including an ordinal number such as first, second, etc. can be used for describing various elements, the constituent elements are not restricted by the terms. The terms are used merely for the purpose of distinguishing an element from the other elements.

Singular expressions include plural expressions, unless the context clearly indicates otherwise.

In the disclosure, the terms such as “include” or “have” may be construed to denote a certain characteristic, number, step, operation, constituent element, component, or a combination thereof, but they may not be construed to exclude the existence of or a possibility of addition of one or more other characteristics, numbers, steps, operations, constituent elements, components, or combinations thereof.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

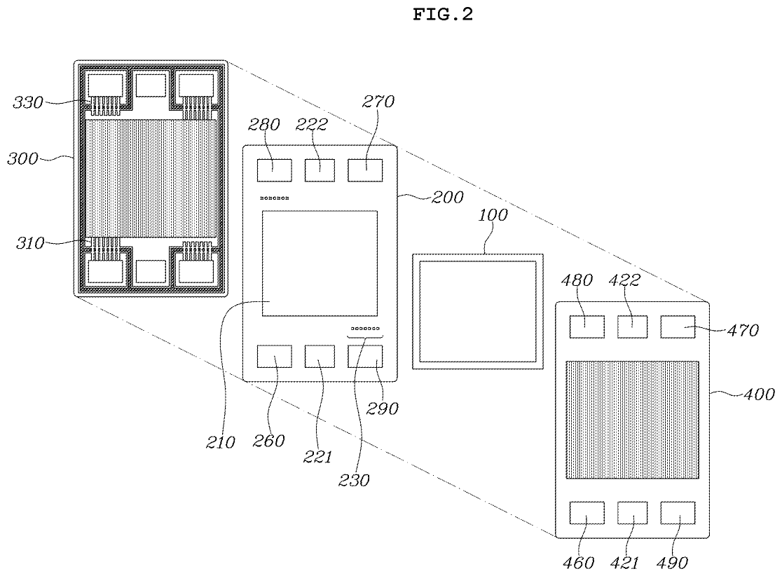

FIG. 2 is a diagram illustrating an exploded view of a unit cell of a fuel cell stack according to an embodiment of the disclosure. Referring to FIG. 2, the unit cell of the fuel cell stack includes an electricity-generating assembly (EGA) in which a membrane-electrode assembly (MEA) and a gas diffusion layer (GDL) are bonded, a sheet 200, a first separator 400, and a second separator 300, wherein the EGA 100 is coupled to the sheet 200, and the second separator 300 and the first separator 400 are coupled to both sides of the sheet 200, respectively.

When the unit cells of the fuel cell stack illustrated in FIG. 2 are stacked, a fuel cell stack is formed.

Meanwhile, in the specification, the first separator 400 may be a cathode separator or an anode separator, and this can be equally applied to the second separator 300. In addition, a first gas may be air or hydrogen, and this may be equally applied to a second gas. However, for convenience of explanation of the embodiments of the disclosure, it is assumed that in the embodiments of the disclosure, the first separator serves as an anode separator and the second separator serves as a cathode separator, and the first gas is hydrogen and the second gas is air.

Specifically, when describing each configuration, the sheet 200 is configured to accommodate the EGA 100. The EGA 100 is a material with ductility and low strength, and the sheet 200 helps the EGA 100 maintain its shape, protects the EGA 100 from external forces, and serves to assist in fixing the EGA 100 within the unit cell.

The sheet 200 is made of a material that can be easily compressed and punched, such as plastic or rubber, and is preferably made of a material that holds the shape of the EGA 100 and has a hardness that can protect the EGA 100. In addition, the sheet 200 may be used in single pieces to accommodate the EGA 100.

Meanwhile, an insertion groove 210 into which the EGA 100 is inserted is formed in the center of the sheet 200. The insertion groove 210 is formed by punching, and the insertion groove 210 is punched into a shape that can accommodate the EGA 100 so that the EGA 100 can be inserted and accommodated in the sheet 200.

The first separator 400 and the second separator 300 are coupled to each side of the sheet 200 to which the EGA 100 is attached. The first separator 400 and the second separator 300 coupled to the sheet 200 are coupled to the sheet 200 through an adhesive 800.

The first separator 400 is coupled to the sheet 200 so that one side of the first separator 400 faces the sheet 200. A first reaction flow field 430 through which the first gas flows is formed on one side of the first separator 400. The first gas may diffuse into the EGA 100 through the first reaction flow field 430 and react with the second gas to generate power.

The second separator 300 is also coupled to the sheet 200 so that one side of the second separator 300 faces the sheet 200. A second reaction flow field 350 through which the second gas flows is formed on one side of the second separator 300. The second gas may diffuse into the EGA 100 through the second reaction flow field 350 and react with the first gas to generate power.

A second gas flow field 310 is formed on one side of the second separator 300 to deliver the second gas to the second reaction flow field 350. The second gas flow field 310 is connected to the second reaction flow field 350, so that the second gas can be delivered to the second reaction flow field 350. A portion of the second gas may flow into the second reaction flow field 350 and react with the first gas, but a portion of the second gas may pass through the second reaction flow field 350 and flow back into the second gas flow field 310.

A first gas flow field 330 is formed on one side of the second separator 300 to deliver the first gas to the first reaction flow field 430. The first gas flow field 330 is formed on one side of the second separator 300 but is connected to the first reaction flow field 430 of the first separator 400. Specifically, referring to FIG. 2, the second gas flow field 310 is connected to the second reaction flow field 350, while the first gas flow field 330 is not connected to the second reaction flow field 350, and one end of the first gas flow field 330 is formed in a bent shape to face the first reaction flow field 430.

That is, the first gas flowing in the first gas flow field 330 flows into the first reaction flow field 430 of the first separator 400 from one end of the first gas flow field 330.

In this case, a through hole 230 is formed in the sheet 200, and the through hole 230 is formed at a point corresponding to the bent point of the first gas flow field 330. Therefore, the first gas moving through the first gas flow field 330 passes through the through hole 230 and flows into the first reaction flow field 430. The through holes 230 may be formed as many as the number of first gas flow fields 330.

In addition, a portion of the first gas may flow into the first reaction flow field 430 and react with the second gas, but a portion of the first gas may pass through the first reaction flow field 430 and again pass through the through hole 230, thereby flowing into the first gas flow field 330 of the second separator 300.

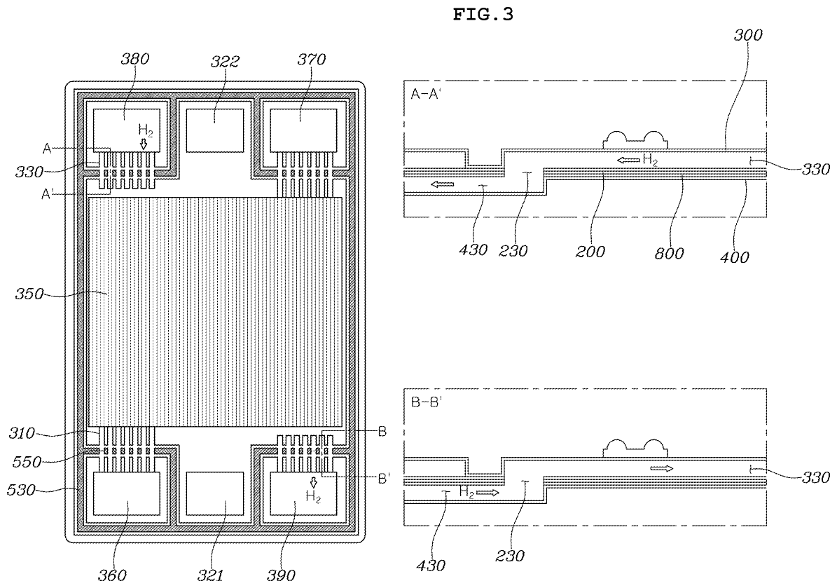

FIG. 3 is a diagram illustrating one side of a second separator of a unit cell where the A-A′ cross section and the B-B′ cross section are illustrated when cells are stacked. Referring to FIG. 3, the flow of the first gas will be described in detail.

Referring first to the A-A′ cross section, the first gas flows into the first gas flow field 330. The first gas flowing into the first gas flow field 330 passes through the through hole 230 along the first gas flow field 330 bent at one end of the first gas flow field 330 and moves to the first reaction flow field 430 of the first separator 400 connected to the first gas flow field 330.

Some of the first gas flowing into the first reaction flow field 430 reacts with the second gas, but some of the first gas passes through the first reaction flow field 430, passes through the through hole 230 again, and flows into the first gas flow field 330 of the second separator 300. That is, referring to the B-B′ cross section, the first gas that has passed through the first reaction flow field 430 passes through the through hole 230 and flows back into the first gas flow field 330 of the second separator 300.

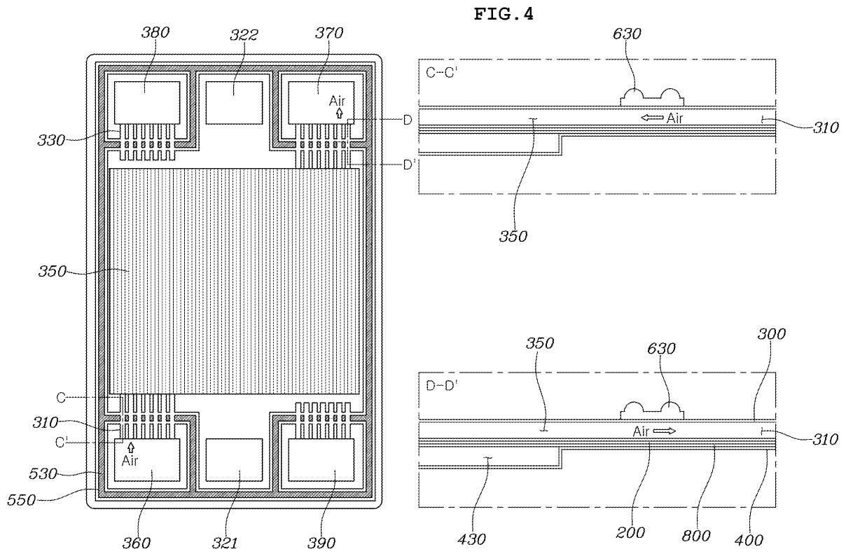

FIG. 4 is a diagram illustrating one side of a second separator of a unit cell where the C-C′ cross section and the D-D′ cross section are illustrated when cells are stacked. Referring to FIG. 4, the flow of the second gas will be described in detail.

Referring first to the C-C′ cross section, the second gas flows into the second gas flow field 310. The second gas flowing into the second gas flow field 310 flows into the second reaction flow field 350 connected to the second gas flow field 310. Some of the second gas flowing into the second reaction flow field 350 reacts with the first gas, but some of the second gas passes through the second reaction flow field 350 and flows into the second gas flow field 310. That is, referring to the D-D′ cross section, it can be seen that the second gas that has passed through the second reaction flow field 350 passes through the second reaction flow field 350 and flows into the second gas flow field 310.

Specifically, the flow of the first gas and the second gas will be described.

A plurality of points at one or more of the first separator 400, the second separator 300, and the sheet 200 have a first gas manifold 380, 390, 280, 290, 480, 490 through which the first gas flows in and out and a second gas manifold 360, 370, 260, 270, 460, 470 through which the second gas flows in and out. The first gas manifolds 380, 390, 280, 290, 480, 490 may be formed as a pair. One first gas manifold 380, 280, 480 may correspond to a part where the first gas flows in, and the other first gas manifold 390, 290, 490 may correspond to a part where the first gas flows out.

Likewise, the second gas manifolds 360, 370, 260, 270, 460, 470 may be formed as a pair. One second gas manifold 360, 260, 460 may correspond to a part where the second gas flows in, and the other second gas manifold 370, 270, 470 may correspond to a part where the second gas flows out.

In particular, the first gas manifold 380, 390 formed on the second separator 300 may be connected to the other end of the first gas flow field 330, and the second gas manifold 360, 370 formed on the second separator 300 may be connected to the other end of the second gas flow field 310.

The first gas manifold 380, 390, 280, 290, 480, 490 and the second gas manifold 360, 370, 260, 270, 460, 470 are preferably formed at points where the first separator 400, the second separator 300, and the sheet 200 correspond to each other. Meanwhile, the first gas manifold 380, 390, 280, 290, 480, 490 and the second gas manifold 360, 370, 260, 270, 460, 470 may be formed to face each other, the pair of first gas manifolds 380, 390, 280, 290, 480, 490 may face each other diagonally, and the second gas manifold 360, 370, 260, 270, 460, 470 may also be formed to face each other diagonally.

Meanwhile, a gasket may be provided in the unit cell of the fuel cell stack to prevent gas outside the unit cell from flowing into the unit cell or gas inside the unit cell from flowing out. Specifically, a gasket 530 may be provided around one or more of the first gas manifold 380, 390, the second gas manifold 360, 370, the second reaction flow field 350, the first gas flow field 330, and the second gas flow field 310 formed on one side of the second separator 300.

Referring to FIGS. 3 and 4, the first gas manifold 380, 390 is provided on one side of the second separator 300, and the gasket 530 is provided around the second gas manifold 360, 370, so that it is possible to prevent the first gas and the second gas from flowing to the outside, and the gasket 530 is also provided around the second reaction flow field 350 to prevent the second gas from flowing to the outside.

In addition, the first separator 400 and the second separator 300 may each be coupled to the sheet 200 through an adhesive. Specifically, the adhesive 800 may be applied around the gasket of the second separator 300 to couple the second separator 300 to the sheet 200.

The adhesive 800 can also be applied to the outer portion of the first separator 400 to couple the first separator 400 to the sheet 200.

That is, there is an adhesive layer formed by the adhesive 800 between the sheet 200 and the first separator 400 and between the sheet 200 and the second separator 300, and there is an advantage that airtightness can be secured between the sheet 200 and the first separator 400 and between the sheet 200 and the second separator 300 by the adhesive layer.

Since the first gas flow field 330 and the second gas flow field 310 are passages through which the first gas and the second gas pass, respectively, the gasket 530 provided around one or more of the first gas flow field 330 and the second gas flow field 310 may be discontinuously provided. However, the gasket 530 provided around one or more of the first gas manifold 380, 390, the second gas manifold 360, 370 and the second reaction flow field 350 may be provided to be continuous so that the first gas manifold 380, 390, the second gas manifold 360, 370, and the second reaction flow field 350 are used to maintain the airtightness of the unit cells of the fuel cell stack.

More specifically, the gasket 530 provided around the first gas flow field 330 or the second gas flow field 310 may be provided between the adjacent first gas flow fields 330 or the adjacent second gas flow fields 310.

The gasket 530 may be injected into the second separator 300 to be provided on the second separator 300. By the gasket 530 being provided overall on the second separator 300, the surface pressure is maintained uniformly when the unit cells are stacked, and the deformation of the first separator 400 and the second separator 300 can be suppressed.

Meanwhile, when the first gas and the second gas react, water is generated inside the unit cell. The generated water can be discharged to the outside by the air pressure caused by the operation of the air compressor, but the water generated around the first gas manifold 380, 390 or the second gas manifold 360, 370 may not escape out due to the gasket 530 provided around the first gas manifold 380, 390 or the second gas manifold 360, 370 and may accumulate inside the unit cell.

The water accumulating inside the unit cell has a negative effect on the durability of the fuel cell stack. For example, when the external temperature drops below freezing, the phase of the water is changed into a solid and the volume increases. The increased volume may cause damage to the internal parts of the unit cell, and the deterioration of the membrane electrode assembly may be accelerated due to an increase in relative humidity inside the unit cell. Therefore, it is necessary to remove the water generated around the first gas manifold 380, 390 or the second gas manifold 360, 370.

The unit cell of the fuel cell stack according to a second embodiment of the disclosure has a gasket 570 provided discontinuously around one or more of the first gas manifold 380, 390 and the second gas manifold 360, 370. Even if water is generated around the first gas manifold 380, 390 or the second gas manifold 360, 370, the water may escape between the discontinuously provided gaskets 570.

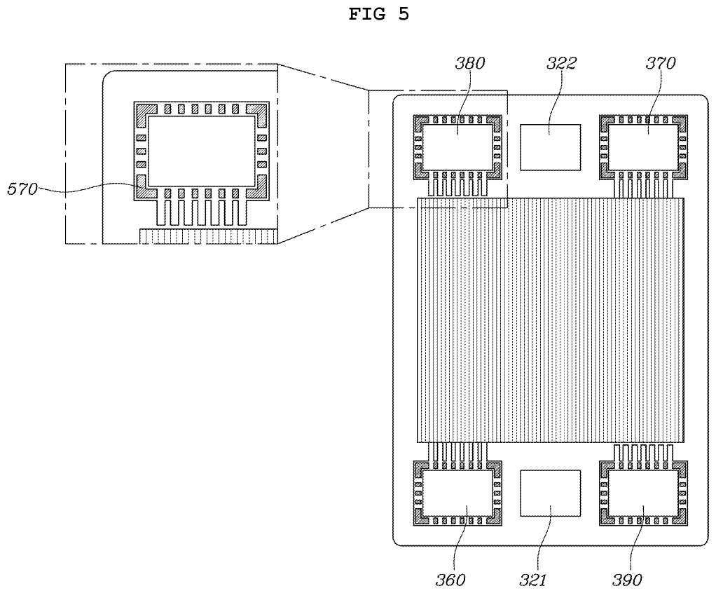

FIG. 5 is a diagram illustrating the gasket provided on the second separator according to the second embodiment. Referring to FIG. 5, the gasket 570 is provided around the first gas manifold 380, 390 and the second gas manifold 360, 370, but unlike FIG. 3, it can be seen that the gasket 570 is discontinuously provided.

Through this, even if water is generated around the first gas manifold 380, 390 or the second gas manifold 360, 370, the water can escape through the discontinuous gasket 570, so that the durability of the fuel cell stack can be prevented from deteriorating due to freezing of accumulated water.

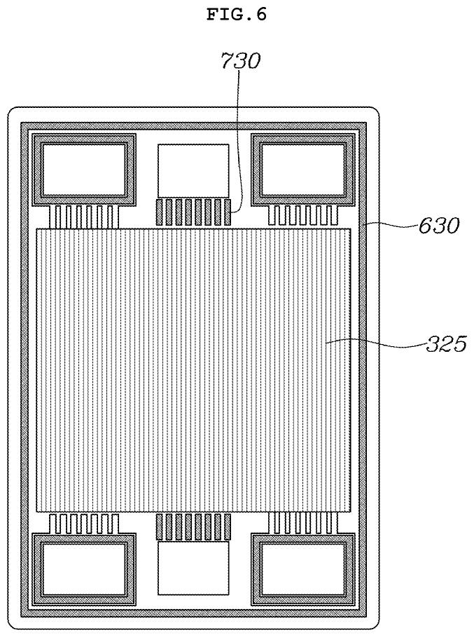

FIG. 6 is a diagram illustrating the cooling surface of a second separator according to the second embodiment.

When the reaction surface is configured according to the second embodiment as illustrated in FIG. 5, the cooling surface can be configured as illustrated in FIG. 6.

As illustrated in FIG. 6, a gasket 630 provided on the other side of the second separator 300 is provided around one or more of the first gas manifold 380, 390 and the second gas manifold 360, 370, and in particular, the gasket 630 may be provided to completely surround one or more of the first gas manifold 380, 390 and the second gas manifold 360, 370.

Meanwhile, as described above, one side of each of the first separator 400 and the second separator 300 constitutes a reaction surface where the first gas and the second gas flow to cause an electrochemical reaction.

On the other hand, the other side of each of the first separator 400 and the second separator 300 forms a cooling surface for cooling the reaction heat generated by the electrochemical reaction of the first gas and the second gas. Therefore, when stacking unit cells, the other side of the first separator 400 and the other side of the second separator 300 may be stacked to face each other.

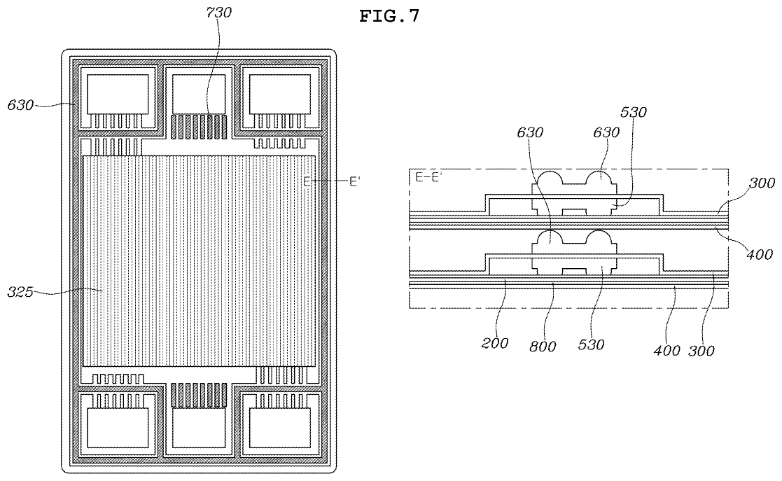

FIG. 7 is a diagram illustrating the E-E′ cross section when the other side of the second separator and cells are stacked.

Referring to FIGS. 2 and 6, a coolant manifold 322, 321, 222, 221, 422, and 421 through which coolant flows in and out may be formed on one of the first separator 400, the second separator 300, and the sheet 200 on which the first gas manifold 380, 390, 280, 290, 480, 490 and the second gas manifold 360, 370, 260, 270, 460, 470 are formed. The coolant may flow into the other side of the first separator 400 and the second separator 300 and flow into the coolant flow field 325 to cool the unit cells of the fuel cell stack, and then may flow out again through the coolant manifold 322, 321, 222, 221, 422, 421.

Meanwhile, the gasket 630 may be provided around one or more of the first gas manifold 380, 390, the second gas manifold 360, 370, the coolant manifold 322, 321, and the coolant flow field 325 formed on the other side of the second separator 300.

Specifically, just as the gasket 530 is provided on one side of the second separator 300 to maintain airtightness, the gasket 630 may be provided on the other side of the second separator 300 to maintain watertightness.

The gasket 630 provided on the other side of the second separator 300 is provided around one or more of the first gas manifold 380, 390 and the second gas manifold 360, 370, and in particular, the gasket 630 may be provided to completely surround one or more of the first gas manifold 380, 390 and the second gas manifold 360, 370.

That is, the gasket 630 may be injected to completely surround the first gas manifold 380, 390 and the second gas manifold 360, 370 to prevent the first or second gas from flowing into the other side of the second separator 300 corresponding to the cooling surface, and the gasket 630 may be injected around the coolant flow field 325 to prevent the coolant from flowing out.

Meanwhile, a gasket 730 may be provided around the coolant manifold 322, 321 formed on the other side of the second separator 300, and the gasket 730 provided around the coolant manifold 322, 321 may be used to guide the flow of the coolant.

By the gasket 630, 730 provided on the other side of the second separator 300, the surface pressure is maintained uniformly when unit cells are stacked, and the deformation of the first separator 400 and the second separator 300 may be suppressed.

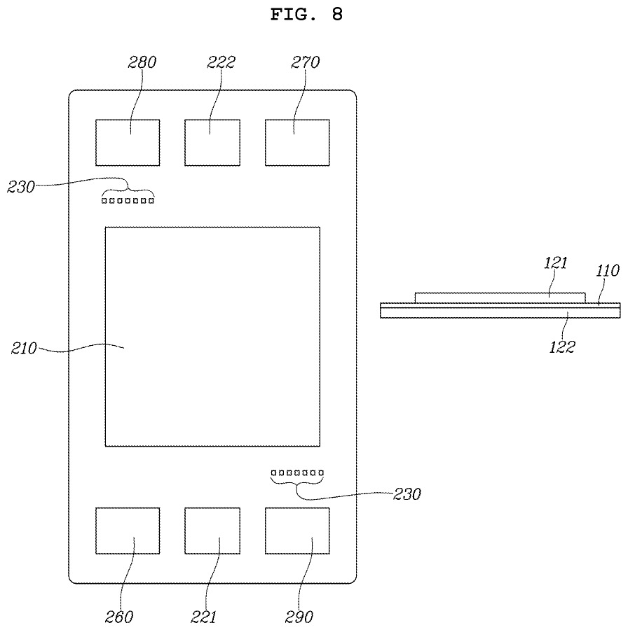

Meanwhile FIG. 8 is a diagram illustrating the EGA coupled to a sheet and the sheet.

Referring to FIG. 8, a gas diffusion layer 121, 122 is bonded to each side of the membrane electrode assembly 110 to form the EGA 100. The gas diffusion layer 121, 122 includes the first gas diffusion layer 121 bonded to one side of the membrane electrode assembly 110 and the second gas diffusion layer 122 bonded to the other side of the membrane electrode assembly 110. In order to stably seat the EGA 100 on the sheet 200, the areas of the first gas diffusion layer 121 and the second gas diffusion layer 122 may be configured differently.

As illustrated in FIG. 8, the area of the first gas diffusion layer 121 is formed to be smaller than the area of the second gas diffusion layer 122, so that when the EGA 100 is inserted into the insertion groove of the sheet 200, as the first gas diffusion layer 121 is inserted into the insertion groove 210, the remaining portion of the sheet 200 may be in contact with the membrane electrode assembly 110.

Although embodiments of the disclosure have been shown and described with respect to specific exemplary embodiments, it will be obvious to those skilled in the art that the embodiments of the disclosure may be variously modified and altered without departing from the spirit and scope of the disclosure as defined by the following claims.

What is claimed is:

1. A unit cell of a fuel cell stack, the unit cell comprising:
an electricity-generating assembly (EGA) in which a membrane electrode assembly and a gas diffusion layer are bonded;
a sheet comprising an insertion groove and a through hole configured to flow a gas therethrough, wherein the EGA is insertable into the insertion groove;
a first separator coupled to the sheet and comprising a first reaction flow field through which a first gas flows on a first side of the first separator; and
a second separator coupled to the sheet and comprising a second reaction flow field through which a second gas flows on a first side of the second separator, a second gas flow field connected to a first end or a second end of the second reaction flow field, and a first gas flow field connected to the first reaction flow field through the through hole disposed in the sheet at a point spaced apart from the second gas flow field.

2. The unit cell of claim 1, wherein the gas diffusion layer of the EGA comprises a first gas diffusion layer and a second gas diffusion layer, an area of the first gas diffusion layer is smaller than an area of the second gas diffusion layer, and the first gas diffusion layer is insertable into the insertion groove of the sheet so that one side of the sheet is in contact with the membrane electrode assembly.

3. The unit cell of claim 1, further comprising a first gas manifold configured to flow the first gas therethrough and a second gas manifold configured to flow the second gas therethrough, wherein the first gas manifold and the second gas manifold are disposed at a plurality of points of the first separator, the second separator, or the sheet.

4. The unit cell of claim 3, wherein the first gas flow field is connected to the first gas manifold disposed in the second separator, and wherein the second gas flow field is connected to the second gas manifold disposed in the second separator.

5. The unit cell of claim 3, wherein the first gas is flowable into the first gas flow field through the first gas manifold, and the first gas flowing into the first gas flow field passes through the through hole of the sheet and flows into the first reaction flow field of the first separator.

6. The unit cell of claim 3, wherein one end of the first gas flow field is bent and connected to the through hole.

7. The unit cell of claim 3, further comprising a gasket disposed around the first gas manifold, the second gas manifold, the second reaction flow field, the first gas flow field, or the second gas flow field disposed on one side of the second separator.

8. The unit cell of claim 7, wherein the gasket comprises:
a first gasket disposed around the first gas manifold, the second gas manifold, or the second reaction flow field; and
a second gasket disposed around the first gas flow field and the second gas flow field.

9. The unit cell of claim 8, wherein the first gasket is continuous and the second gasket is discontinuous.

10. The unit cell of claim 7, wherein the gasket is disposed between adjacent first gas flow fields or adjacent second gas flow fields.

11. The unit cell of claim 7, wherein the gasket is disposed around the first gas manifold or the second gas manifold, and wherein the gasket is discontinuous.

12. The unit cell of claim 3, further comprising:
a coolant manifold through which a coolant is flowable disposed on the first separator, the second separator, or the sheet on which the first gas manifold and the second gas manifold are disposed; and
a coolant flow field through which the coolant is flowable disposed on a second side of the first separator or the second separator.

13. The unit cell of claim 12, further comprising a gasket disposed around the first gas manifold, the second gas manifold, the coolant manifold, or the coolant flow field disposed on the second side of the second separator.

14. The unit cell of claim 13, wherein the gasket surrounds the first gas manifold or the second gas manifold.

15. The unit cell of claim 1, further comprising:
a first gasket disposed on the first side of the second separator and a second gasket disposed on a second side of the second separator; and
an adhesive around the first gasket to attach the second separator to the sheet.

16. A unit cell of a fuel cell stack, the unit cell comprising:
an electricity-generating assembly (EGA) in which a membrane electrode assembly and a gas diffusion layer are bonded;
a sheet comprising an insertion groove and a through hole configured to flow a gas therethrough, wherein the EGA is insertable into the insertion groove;
a first separator coupled to the sheet and comprising a first reaction flow field through which a first gas flows on a first side of the first separator; and
a second separator coupled to the sheet and comprising a second reaction flow field through which a second gas flows on a first side of the second separator, a second gas flow field connected to a first end or a second end of the second reaction flow field, and a first gas flow field connected to the first reaction flow field through the through hole disposed in the sheet at a point spaced apart from the second gas flow field, wherein an end of the first gas flow field is bent and connected to the through hole.

17. The unit cell of claim 16, wherein the gas diffusion layer of the EGA comprises a first gas diffusion layer and a second gas diffusion layer, an area of the first gas diffusion layer is smaller than an area of the second gas diffusion layer, and the first gas diffusion layer is insertable into the insertion groove of the sheet so that one side of the sheet is in contact with the membrane electrode assembly.

18. The unit cell of claim 16, further comprising a first gas manifold configured to flow the first gas therethrough and a second gas manifold configured to flow the second gas therethrough, wherein the first gas manifold and the second gas manifold are disposed at a plurality of points of the first separator, the second separator, or the sheet.

19. The unit cell of claim 18, further comprising a gasket disposed around the first gas manifold, the second gas manifold, the second reaction flow field, the first gas flow field, or the second gas flow field disposed on one side of the second separator.

20. The unit cell of claim 16, further comprising:
a first gasket disposed on the first side of the second separator and a second gasket disposed on a second side of the second separator; and
an adhesive around the first gasket to attach the second separator to the sheet.
